(19) United States
(12) Patent Application Publication
(10) Pub. No.: US 2012/0308771 A1
(43) Pub. Date: Dec. 6, 2012

(54) NANOSTRUCTURE FILMS

(76) Inventors: Paul Drazaic, Morgan Hill, CA (US); David Hecht, San Carlos, CA (US); Michael O'Connell, San Jose, CA (US); Glen Irvin, Newark, CA (US)

(21) Appl. No.: 13/485,022

(22) Filed: May 31, 2012

Related U.S. Application Data
(62) Division of application No. 12/246,004, filed on Oct. 6, 2008, now abandoned.
(60) Provisional application No. 60/978,052, filed on Oct. 5, 2007.

(51) Int. Cl. B05D 5/12; B32B 3/10; B82Y 30/00

(52) U.S. Cl. 428/131; 427/58; 427/122; 977/750; 977/752; 977/734

(57) ABSTRACT

A nanostructure film, comprising at least one interconnected network of nanostructures, wherein the nanostructure film is optically transparent and electrically conductive. A method for improving the optoelectronic properties of a nanostructure film, comprising: forming a nanostructure film having a thickness that, if uniform, would result in a first optical transparency and a first sheet resistance that are lower than desired; and patterning holes in the nanostructure film, such that a desired higher second optical transparency and a second sheet resistance are achieved. A method for depositing a nanostructure film on a rigid substrate comprises: depositing the nanostructure film on a flexible substrate; and transferring the nanostructure film from the flexible substrate to a rigid substrate, wherein the flexible substrate comprises at least one of a release liner and a heat- or chemical-sensitive adhesive layer.

### CROSS-REFERENCE TO RELATED APPLICATIONS

This nonprovisional application is a divisional of, and claims priority under 35 U.S.C. §120 to U.S. application Ser. No. 12/246,004, filed on Oct. 6, 2008, which claims priority under 35 U.S.C. §119 to U.S. Provisional Patent Application No. 60/978,052, filed on Oct. 5, 2007, in the United States Patent and Trademark Office. The entire contents of each of the above-mentioned applications are incorporated herein by reference.

### FIELD OF THE INVENTION

The present invention relates generally to nanostructure films, and more specifically to nanostructure films having holes therein to increase optoelectronic performance and/or nanostructure films deposited on rigid substrates from flexible substrates.

### BACKGROUND OF THE INVENTION

Many modem and/or emerging applications require at least one device electrode that has not only high electrical conductivity, but high optical transparency as well. Such applications include, but are not limited to, touch screens (e.g., analog, resistive, 4-wire resistive, 5-wire resistive, surface capacitive, projected capacitive, multi-touch, etc.), displays (e.g., flexible, rigid, electro-phoretic, electro-luminescent, electrochromatic, liquid crystal (LCD), plasma (PDP), organic light emitting diode (OLED), etc.), solar cells (e.g., silicon (amorphous, protocrystalline, nanocrystalline), cadmium telluride (CdTe), copper indium gallium selenide (CIGS), copper indium selenide (CIS), gallium arsenide (GaAs), light absorbing dyes, quantum dots, organic semiconductors (e.g., polymers, small-molecule compounds)), solid state lighting, fiber- optic communications (e.g., electro-optic and opto-electric modulators) and microfluidics (e.g., electrowetting on dielectric (EWOD)).

As used herein, a layer of material or a sequence of several layers of different materials is said to be “transparent” when the layer or layers permit at least 50% of the ambient electromagnetic radiation in relevant wavelengths to be transmitted through the layer or layers. Similarly, layers which permit some but less than 50% transmission of ambient electromagnetic radiation in relevant wavelengths are said to be “semi-transparent.”

Currently, the most common transparent electrodes are transparent conducting oxides (TCOs), specifically indium-tin-oxide (ITO), that are typically applied to a transparent substrate. However, ITO can be an inadequate solution for many of the above-mentioned applications (e.g., due to its relatively brittle nature, correspondingly inferior flexibility and abrasion resistance), and the indium component of ITO is rapidly becoming a scarce commodity. Additionally, ITO deposition usually requires expensive, high-temperature sputtering, which can be incompatible with many device process flows. Hence, more robust, abundant and easily-deposited transparent conductor materials are being explored.

### SUMMARY OF THE INVENTION

Certain embodiments of the present invention involve a nanostructure film, comprising at least one interconnected network of nanostructures, wherein the nanostructure film is optically transparent and electrically conductive.

In another embodiment, the nanostructure film further comprises a pattern within the nanostructure film.

In yet another embodiment, the nanostructure film comprises a pattern within the nanostructure film, wherein the pattern is a pattern of microscale holes.

In yet another embodiment, the nanostructure film comprises a pattern within the nanostructure film, wherein the pattern is a regular pattern of microscale holes.

In yet another embodiment, the nanostructure film comprises a pattern within the nanostructure film, wherein the pattern is a regular pattern of microscale holes, and wherein the nanostructure film further comprises at least one of a hydrophobic polymer, a block copolymer and a lift-off layer between the nanostructure film and an underlying substrate.

Another embodiment involves a method for improving the optoelectronic properties of a nanostructure film, comprising: forming a nanostructure film having a thickness that, if uniform, would result in a first optical transparency and a first sheet resistance that are lower than desired; and patterning holes in the nanostructure film, such that a desired higher second optical transparency and a second sheet resistance are achieved.

In yet another embodiment, a method for improving the optoelectronic properties of a nanostructure film comprises forming a nanostructure film having a thickness that, if uniform, would result in a first optical transparency and a first sheet resistance that are lower than desired; and patterning holes in the nanostructure film, such that a desired higher second optical transparency and a second sheet resistance are achieved, and wherein the holes are patterned by depositing at least one of a hydrophobic polymer, a block copolymer and a lift-off layer between the nanostructure film and an underlying substrate.

In yet another embodiment, a method for depositing a nanostructure film on a rigid substrate comprises: depositing the nanostructure film on a flexible substrate; and transferring the nanostructure film from the flexible substrate to a rigid substrate, wherein the flexible substrate comprises at least one of a release liner and a heat- or chemical-sensitive adhesive layer.

### BRIEF DESCRIPTION OF THE DRAWINGS

The invention is better understood from reading the following detailed description of the preferred embodiments, with reference to the accompanying figures in which:

FIG. 1 is a scanning electron microscope (SEM) image of a nanostructure film according to one embodiment of the present invention;

FIG. 2A is a schematic representation of a nanostructure film according to an embodiment of the present invention, as compared with a uniform nanostructure film as depicted in FIG. 2B.

Features, elements, and aspects of the invention that are referenced by the same numerals in different figures represent the same, equivalent, or similar features, elements, or aspects in accordance with one or more embodiments of the system.

### DETAILED DESCRIPTION OF THE EMBODIMENTS

The present invention describes nanostructure films. Nanostructures have attracted a great deal of recent attention due to their exceptional material properties. Nanostructures may include, but are not limited to, nanotubes (e.g., single-walled carbon nanotubes (SWNTs), multi-walled carbon nanotubes (MWNTs), double-walled carbon nanotubes (DWNTs), few-walled carbon nanotubes (FWNTs)), other fullerenes (e.g., buckyballs), graphene flakes/sheets, and/or nanowires (e.g., metallic (e.g., Ag, Ni, Pt, Au), semiconducting (e.g., InP, Si, GaN), dielectric (e.g., SiO₂, TiO₂), organic, inorganic). Nanostructure films may comprise at least one interpenetrating network of such nanostructures, and may similarly exhibit exceptional material properties. For example, nanostructure films comprising at least one interconnected network of carbon nanotubes (e.g., wherein nanostructure density is above a percolation threshold) can exhibit extraordinary strength and electrical conductivity, as well as efficient heat conduction and substantial optical transparency.

Other features and advantages of the invention will be apparent from the accompanying drawings and from the detailed description. One or more of the above-disclosed embodiments, in addition to certain alternatives, are provided in further detail below with reference to the attached figures. The invention is not limited to any particular embodiment disclosed; the present invention may be employed in not only transparent conductive film applications, but in other nanostructure applications as well (e.g., nontransparent electrodes, transistors, diodes, conductive composites, electrostatic shielding, etc.).

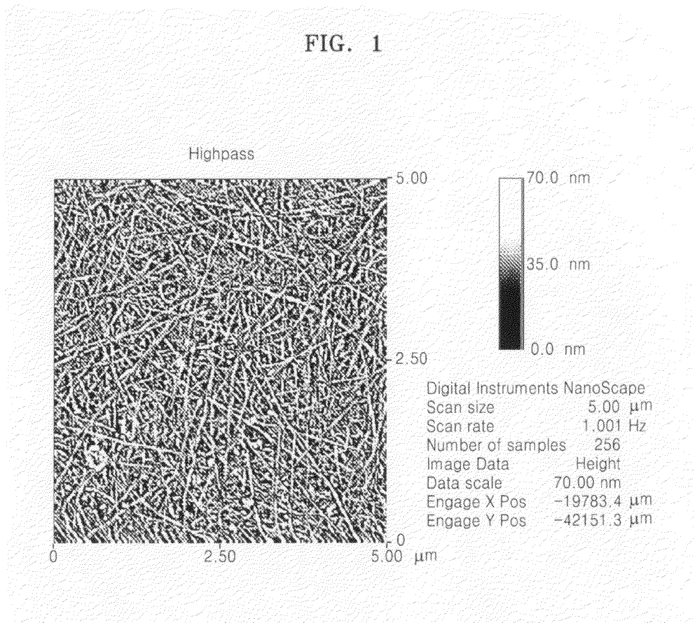

Referring to FIG. 1, a nanostructure film according to one embodiment of the present invention comprises at least one interconnected network of single-walled carbon nanotubes (SWNTs). Such film may additionally or alternatively comprise other nanotubes (e.g., MWNTs, DWNTs), other fullerenes (e.g., buckyballs), graphene flakes/sheets, and/or nanowires (e.g., metallic (e.g., Ag, Ni, Pt, Au), semiconducting (e.g., InP, Si, GaN), dielectric (e.g., SiO₂, TiO₂), organic, inorganic).

Such nanostructure film may further compose at least one functionalization material bonded to the nanostructure film. For example, a dopant bonded to the nanostructure film may increases the electrical conductivity of the film by increasing carrier concentration. Such dopant may comprise at least one of Iodine (I₂), Bromine (Br₂), polymer-supported Bromine (Br₂), Antimonypentafluride (SbF₅), Phosphoruspentachloride (PCl₅), Vanadiumoxytrifluride (VOF₃), Silver(II)Fluoride (AgF₂), 2,1,3-Benzoxadiazole-5-carboxylic acid, 2-(4-Biphenylyl)-5-phenyl-1,3,4-oxadiazole, 2,5-Bis-(4-aminophenyl)-1,3,4-oxadiazole, 2-(4-Bromophenyl)-5-phenyl-1,3,4-oxadiazole, 4-Chloro-7-chlorosulfonyl-2,1,3-benzoxadiazole, 2,5-Diphenyl-1,3,4-oxadiazole, 5-(4-Methoxyphenyl)-1,3,4-oxadiazole-2-thiol, 5-(4-Methylphenyl)-1,3,4-oxadiazole-2-thiol, 5-Phenyl-1,3,4-oxadiazole-2-thiol, 5-(4-Pyridyl)-1,3,4-oxadiazole-2-thiol, Methyl viologen dichloride hydrate, Fullerene-C60, N-Methylfulleropyrrolidine, N,N′-Bis(3-methylphenyl)-N,N′-diphenylbenzidine, Triethylamine (TEA), Triethanolanime (TEA)—OH, Trioctylamine, Triphenylphosphine, Trioctylphosphine, Triethylphosphine, Trinapthylphosphine, Tetradimethylaminoethene, Tris(diethylamino)phosphine, Pentacene, Tetracene, N,N′-Di-[(1-naphthyl)-N,N′- diphenyl]-1,1′-biphenyl)-4,4′-diamine sublimed grade, 4-(Diphenylamino)benzaldehyde, Di-p-tolylamine, 3-Methyldiphenylamine, Triphenylamine, Tris[4-(diethylamino)phenyl]amine, Tri-p-tolylamine, Acradine Orange base, 3,8-Diamino-6-phenylphenanthridine, 4-(Diphenylamino)benzaldehyde diphenylhydrazone, Poly(9-vinylcarbazole), Poly(1-vinylnaphthalene), Triphenylphosphine, 4Carboxybutyl)triphenylphosphonium bromide, Tetrabutylammonium benzoate, Tetrabutylammonium hydroxide 30-hydrate, Tetrabutylammonium triiodide, Tetrabutylammonium bis-trifluoromethanesulfonimidate, Tetraethylammonium trifluoromethanesulfonate, Oleum (H₂SO₄—SO₃), Triflic acid and/or Magic Acid.

Such dopant may be bonded covalently or noncovalently to the film. Moreover, the dopant may be bonded directly to the film or indirectly through and/or in conjunction with another molecule, such as a stabilizer that reduces desorption of dopant from the film. The stabilizer may be a relatively weak reducer (electron donor) or oxidizer (electron acceptor), where the dopant is a relatively strong reducer (electron donor) or oxidizer (electron acceptor) (i.e., the dopant has a greater doping potential than the stabilizer). Additionally or alternatively, the stabilizer and dopant may comprise a Lewis base and Lewis acid, respectively, or a Lewis acid and Lewis base, respectively. Exemplary stabilizers include, but are not limited to, aromatic amines, other aromatic compounds, other amines, imines, trizenes, boranes, other boron-containing compounds and polymers of the preceding compounds. Specifically, poly (4-vinylpyridine) and/or tri-phenyl amine have displayed substantial stabilizing behavior in accelerated atmospheric testing (e.g., 1000 hours at 65° C. and 90% relative humidity).

Stabilization of a dopant bonded to a nanostructure film may also or alternatively be enhanced through use of an encapsulant. The stability of a non-functionalized or otherwise functionalized nanostructure film may also be enhanced through use of an encapsulant. Accordingly, yet another embodiment of the present invention comprises a nanostructure film coated with at least one encapsulation layer. This encapsulation layer preferably provides increased stability and environmental (e.g., heat, humidity and/or atmospheric gases) resistance. Multiple encapsulation layers (e.g., having different compositions) may be advantageous in tailoring encapsulant properties. Exemplary encapsulants comprise at least one of a fluoropolymer, acrylic, silane, polyimide and/or polyester encapsulant (e.g., PVDF (Hylar CN, Solvay), Teflon AF, Polyvinyl fluoride (PVF), Polychlorotrifluoroethylene (PCTFE), Polyvinylalkyl vinyl ether, Fluoropolymer dispersion from Dupont (TE 7224), Melamine/Acrylic blends, conformal acrylic coating dispersion, etc.). Encapsulants may additionally or alternatively comprise UV and/or heat cross-linkable polymers (e.g., Poly(4-vinyl-phenol)).

A nanostructure film according to one embodiment may also comprise application-specific additives. For example, thin nanotube films can be inherently transparent to infrared radiation, thus it may be advantageous to add an infrared (IR) absorber thereto to change this material property (e.g., for window shielding applications). Exemplary IR absorbers include, but are not limited to, at least one of a cyanine, quinone, metal complex, and photochronic. Similarly, UV absorbers may be employed to limit the nanostructure film's level of direct UV exposure.

A nanostructure film according to one embodiment may be fabricated using solution-based processes. In such processes, nanostructures may be initially dispersed in a solution with a solvent and dispersion agent. Exemplary solvents include, but are not limited to, deionized (DI) water, alcohols and/or benzo-solvents (e.g., tolulene, xylene). Exemplary dispersion agents include, but are not limited to, surfactants (e.g., sodium dodecyl sulfate (SDS), Triton X, NaDDBS) and biopolymers (e.g., carboxymethylcellulose (CMC)). Coating aids may also be employed in the solution to attain desired coating parameters, e.g., wetting and adhesion to a given substrate; additionally or alternatively, coating aids may be applied to the substrate. Exemplary coating aids include, but are not limited to, aerosol OT, fluorinated surfactants (e.g., Zonyl FS300, FS500, FS62A), alcohols (e.g., hexanol, heptanol, octanol, nonanol, decanol, undecanol, dodecanol, saponin, ethanol, propanol, butanol and/or pentanol), triethanol amine, aliphatic amines (e.g., primary, tertiary, quartinary), TX-100, FT248, Tergitol TMN-10, Olin 10G and/or APG325. Dispersion may be further aided by mechanical agitation, such as by cavitation (e.g., using probe and/or bath sonicators), shear (e.g., using a high-shear mixer and/or roto-stator), resonance and/or homogenization (e.g., using a homogenizer).

The resulting dispersion may be coated onto a substrate using a variety of coating methods. Coating may entail a single or multiple passes, depending on the dispersion properties, substrate properties and/or desired nanostructure film properties. Exemplary coating methods include, but are not limited to, spray-coating, dip-coating, drop-coating and/or casting, roll-coating, transfer-stamping, slot-die coating, curtain coating, [micro]gravure printing, flexoprinting and/or inkjet printing. Exemplary substrates may be flexible or rigid, and include, but are not limited to, glass and/or plastics (e.g., polyethylene terephthalate (PET), polyethylene naphthalate (PEN), polycarbonate (PC) and/or polyethersulfone (PES)). Flexible substrates may be advantageous in having compatibility with roll-to-roll (a.k.a. reel-to-reel) processing, wherein one roll supports uncoated substrate while another roll supports coated substrate. As compared to a batch process, which handles only one component at a time, a roll-to- roll process represents a dramatic deviation from current manufacturing practices, and can reduce capital equipment and product costs, while significantly increasing throughput.

Once coated onto a substrate, the dispersion may be heated to remove solvent therefrom, such that a nanostructure film is formed on the substrate. Exemplary heating devices include a hot plate, heating rod, heating coil and/or oven. The resulting film may be subsequently washed (e.g., with a rinsing agent such as water, ethanol, acetone, toluene and/or IPA) and/or oxidized (e.g., baked and/or rinsed with an oxidizer such as nitric acid, sulfuric acid and/or hydrochloric acid) to remove residual dispersion agent and/or coating aid therefrom. The effectiveness of any given rinsing agent may depend on the nature of the dispersion agent and/or coating aid being removed thereby (e.g., while relatively-high dipole moment rinsing agents such as water may be effective in removing SDS, certain dispersion reagents like Triton X may be more-effectively removed by relatively-low dipole moment rinsing agents, such as Toluene).

Dopant, other additives and/or encapsulant may further be added to the film. Such materials may be applied to the nanostructures in the film before, during and/or after film formation, and may, depending on the specific material, be applied in gas, solid and/or liquid phase (e.g., gas phase NO₂ or liquid phase nitric acid (HNO₃) dopants). Such materials may moreover be applied through controlled techniques, such as the coating techniques enumerated above in the case of liquid phase materials (e.g., slot-die coating a polymer encapsulant).

A nanostructure film according to one embodiment may be patterned before (e.g., using lift-off methods, pattern-pretreated substrate), during (e.g., patterned transfer printing, inkjet printing) and/or after (e.g., using laser ablation and/or masking/etching techniques) fabrication on a substrate. Carbon nanostructure films in particular may be patterned by relatively low-impact methods, such as low-power laser ablation and/or dry etching with inert gases and/or atmospheric oxygen.

In one exemplary embodiment, a nanostructure film comprising an interconnected network of SWNTs was fabricated on a transparent and flexible plastic substrate via a multi-step spray and wash process. A SWNT dispersion was initially formulated by dissolving commercially-available SWNT powder (e.g., P3 from Carbon Solutions) in deionized (DI) water with 1% SDS, and probe sonicated for 30 minutes at 300 W power. The resulting dispersion was then centrifuged at 10,000 rcf (relative centrifugal field) for 1 hour, to remove large agglomerations of SWNTs and impurities (e.g., amorphous carbon and/or residual catalyst particles). In parallel, a PC substrate was immersed in a silane solution (a coating aid comprising 1% weight of 3-aminopropyltriethoxysilane in DI water) for approximately five minutes, followed by rinsing with DI water and blow drying with nitrogen. The resulting pre-treated PC substrate (Tekra 0.03″ thick with hard coating) was then spray-coated over a 100° C. hot plate with the previously-prepared SWNT dispersion, immersed in DI water for 1 minute, then sprayed again, and immersed in DI water again. This process of spraying and immersing in water may be repeated multiple times until a desired sheet resistance (e.g., film thickness) is achieved.

In a related exemplary embodiment, a doped nanostructure film comprising an interconnected network of SWNTs was fabricated on a transparent and flexible substrate using the methods described in the previous example, but with a SWNT dispersion additionally containing a TCNQF₄ dopant. In another related embodiment, this doped nanostructure film was subsequently encapsulated by spin-coating a layer of parylene thereon and baking. In yet another related embodiment, the nanostructure film was patterned using a solid-state UV laser (green); single passes with the laser effectively patterned the nanostructure film to resolutions below about 5-10 microns, even at power levels as low as 17 W and on a roll-to-roll apparatus moving the film at 2 meters/second.

In another exemplary embodiment, a SWNT dispersion was first prepared by dissolving SWNT powder (e.g., P3 from Carbon Solutions) in DI water with 1% SDS and bath-sonicated for 16 hours at 100 W, then centrifuged at 15000 ref for 30 minutes such that only the top ¾ portion of the centrifuged dispersion is selected for further processing. The resulting dispersion was then vacuum filtered through an alumina filter with a pore size of 0.1-0.2 μm (Watman Inc.), such that a SWNT film forms on the filter. DI water was subsequently vacuum filtered through the film for several minutes to remove SDS. The resulting film was then transferred to a PET substrate by a PDMS (poly-dimethylsiloxane) based transfer printing technique, wherein a patterned PDMS stamp is first placed in conformal contact with the film on the filter such that a patterned film is transferred from the filter to the stamp, and then placed in conformal contact with the PET substrate and heated to 80° C. such that the patterned film is transferred to the PET. In a related exemplary embodiment, this patterned film may be subsequently doped via immersion in a gaseous NO₂ chamber. In another related exemplary embodiment, the film may be encapsulated by a layer of PMPV, which, in the case of a doped film, can reduce desorption of dopant from the film.

In yet another exemplary embodiment, a doped and encapsulated nanostructure film comprising an interconnected network of FWNTs was fabricated on a transparent and flexible substrate. CVD-grown FWNTs (OE grade from Unidym, Inc.) were first dissolved in DI water with 0.5% Triton-X, and probe sonicated for one hour at 300 W power. The resulting dispersion was then slot-die coated onto a PET substrate, and baked at about 100° C. to evaporate the solvent. The Triton-X was subsequently removed from the resulting FWNT film by immersing the film for about 15-20 seconds in nitric acid (10 molar). Nitric acid may be effective as both an oxidizing agent for surfactant removal, and a doping agent as well, improving the sheet resistance of the film from 498 ohms/sq to about 131 ohms/sq at about 75% transparency, and 920 ohms/sq to about 230 ohms/sq at 80% transparency in exemplary films. In related exemplary embodiments, these films were subsequently coated with triphenylamine which stabilized the dopant (i.e., the film exhibited a less than 10% change in conductivity after 1000 hours under accelerated aging conditions (65° C.)). In other related exemplary embodiments, the films were then encapsulated with Teflon AF.

In another exemplary embodiment, FWNT powder was initially dispersed in water with SDS (e.g., 1%) surfactant by sonication (e.g., bath sonication for 30 minutes, followed by probe sonication for 30 minutes); 1-dodecanol (e.g., 0.4%) was subsequently added to the dispersion by sonication (e.g., probe sonication for 5 minutes) as a coating aid, and the resulting dispersion was Meyer rod coated onto a PEN substrate. SDS was then removed by rinsing the film with DI water, and the 1-dodecanol was removed by rinsing with ethanol. This sample passed an industry-standard “tape test,” (i.e., the FWNT film remained on the substrate when a piece of Scotch tape was pressed onto and then peeled off of the film); such adhesion between the FWNT film and PEN was not achieved with SDS dispersions absent use of a coating aid.

In one embodiment, a nanostructure film may be patterned into a micro-scale grid. Such a grid may provide advantageous optoelectronic performance, by virtue of the respective logarithmic and linear scaling of optical transmission and electrical conductivity. The grid may be patterned using, for example, one of the aforementioned patterning techniques, e.g., etching holes in the film once formed, patterning a lift-off and/or hydrophobic layer (e.g., from Applied Microstructures, Inc.) on a substrate prior to deposition, printing a patterned nanostructure film. Additionally or alternatively, the grid may be patterned by selectively pre-treating a substrate (e.g., with block copolymers) such that a nanostructure film forms only on certain areas of the substrate. Various grid spacing (e.g., nano-scale, micro-scale and/or macro-scale) and grid geometries (e.g., using linear, polygonal and/or elliptical holes/patterns) may be employed, while maintaining electrically conductive pathways through the film.

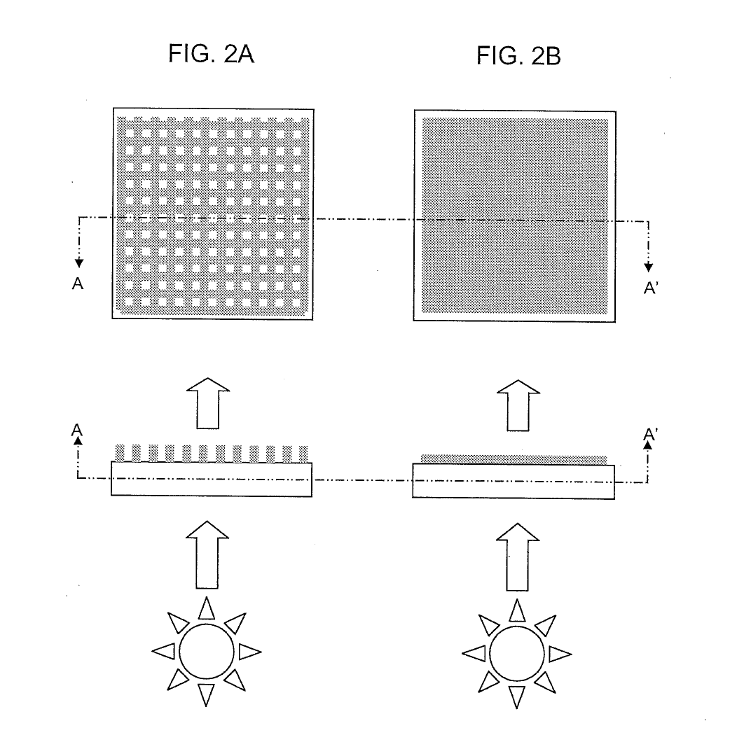

Referring to FIGS. 2A and 2B, in an exemplary embodiment, a first nanostructure film (FIG. 2A) comprises an interconnected network of FWNTs that is patterned such that the nanostructure film covers only half of the area of an underlying substrate due to holes etched therein. As compared to a second nanostructure film (FIG. 2B) that is unpatterned and half as thick, but which has the same composition, as the first nanostructure film, the first nanostructure film can have increased overall optical transparency with at least equivalent electrical sheet conductivity. For example, if the nanostructure film such as FIG. 2B has a sheet resistance of 500 ohms/sq and an optical transparency of 90%, the nanostructure film such as FIG. 2A may have an overall sheet resistance of 500 ohms/sq and an optical transparency of 90.5% (i.e., coated portions of the nanostructure film as in FIG. 2A may have a sheet resistance of 250 ohms/sq and an optical transparency of 81% by virtue of their doubled thickness, while uncoated portions of the nanostructure film as in FIG. 2A will have infinite sheet resistance and 100% optical transparency). Even a 0.5% boost in optical transparency can be significant in many applications. Moreover, higher boosts can be obtained through further, similar increases in pattern size and film thickness.

In another embodiment, the nanostructure film comprises an interconnected network of nanostructures such as carbon nanotubes (e.g., single-walled carbon nanotubes (SWNTs), multi-walled carbon nanotubes (MWNTs), double-walled carbon nanotubes (DWNTs), few-walled carbon nanotubes (FWNTs)), other fullerenes (e.g., buckyballs), graphene flakes/sheets, and/or nanowires (e.g., metallic (e.g., Ag, Ni, Pt, Au), semiconducting (e.g., InP, Si, GaN), dielectric (e.g., SiO₂, TiO₂), organic, inorganic) that are patterned such that the nanostructure film covers only a portion of the area of an underlying substrate due to holes etched therein. In another embodiment, the holes are of different shapes. The holes may have regular shapes or irregular shapes. For example, the holes may have regular shapes, such as square, rectangular, hexagonal, octagonal, round, oval, etc. The holes may be of the same size or of various sizes. In general, the holes would be of a size in the range of about 1 micron to about 1 millimeter in cross-sectional dimension.

In another embodiment, the nanostructure film comprising an interconnected network of carbon nanotubes covers a portion of the area of an underlying substrate. For example, the interconnected network of carbon nanotubes could cover from about 1% to about 99% of the area of the underlying substrate. In another embodiment the interconnected network of carbon nanotubes covers from about 1% to about 75% of the area of the underlying substrate. In another embodiment the interconnected network of carbon nanotubes covers from about 1% to about 50% of the area of the underlying substrate. In another embodiment the interconnected network of carbon nanotubes covers from about 1% to about 25% of the area of the underlying substrate. In another embodiment the interconnected network of carbon nanotubes covers from about 1% to about 10% of the area of the underlying substrate. In another embodiment the interconnected network of carbon nanotubes covers from about 1% to about 5% of the area of the underlying substrate.

In another embodiment, a nanostructure film may be transferred printed from a flexible substrate to a rigid substrate. In another embodiment, the nanostructure film may be patterned (e.g., as a grid) on the flexible substrate, during transfer and/or on the rigid substrate. For example, a nanostructure film may be first formed on a release liner-coated plastic substrate in a roll-to-roll process as described in one or more of the above embodiments, and subsequently transferred to a glass substrate by placing the film in conformal contact with the glass substrate and pulling away the release liner (e.g., silicone-based adhesive). Similarly, a lamination method may be used in which an adhesive layer on the flexible substrate may be dissolved, for example, thermally (e.g., by heat, laser transfer) and/or chemically (e.g., acid treatment). The rigid substrate may be pre-treated and/or coated with an adhesive layer that aids nanostructure-film transfer thereto.

The present invention has been described above with reference to preferred features and embodiments. Those skilled in the art will recognize, however, that changes and modifications may be made in these preferred embodiments without departing from the scope of the present invention.

What is claimed is:

1. A method for improving the optoelectronic properties of a nanostructure film, comprising:
forming a nanostructure film having a thickness that, if uniform, would result in a first optical transparency and a first sheet resistance that are lower than desired; and
patterning holes in the nanostructure film, such that a desired higher second optical transparency and a second sheet resistance are achieved.

2. The method of claim 1, wherein the holes are patterned by depositing at least one of a hydrophobic polymer, a block copolymer and a lift-off layer between the nanostructure film and an underlying substrate.

3. The method of claim 2, wherein the patterning the holes includes opening a pattern of microscale holes in the nanostructure film.

4. The method of claim 3, wherein the forming a pattern of microscale holes includes forming a pattern of microscale holes that are of the same size or shape.

5. The method of claim 1, wherein the patterned nanostructure film covers from 1% to about 50% of an area of an underlying substrate.

6. The method of claim 1, wherein the nanostructure film is formed via a multi-step spray and wash process.

7. The method of claim 6, wherein the spray and wash process is multiple times until the thickness is achieved.

8. The method of claim 1, wherein the forming the nanostructure film comprises:
dispersing nanostructures in a solution with solvent and a dispersion agent to achieve a dispersion;
coating the dispersion on a substrate;
heating the dispersion to remove the solvent, such that the nanostructure film is formed on the substrate; and
washing the nanostructure film to remove the dispersion agent.

9. The method of claim 8, wherein the nanostructures include at least one of single-walled carbon nanotubes, multi-walled nanotubes, fullerenes, graphene flakes, metallic nanowires, semiconducting nanowires, dielectric nanowires, organic nanowires, and inorganic nanowires.

10. The method of claim 1, further comprising:
adding at least one functionalization material bonded to the nanostructure film.

11. The method of claim 10, wherein the functionalization material includes one of at least one of Iodine (I₂), Bromine (Br₂), polymer-supported Bromine (Br₂), Antimonypentafluride (SbF₅), Phosphoruspentachloride (PCI₅), Vanadiumoxytrifluride (VOF₃), Silver(II)Fluoride (AgF₂), 2,1,3-Benzoxadiazole-5-carboxylic acid, 2-(4-Biphenylyl)-5-phenyl-1,3,4-oxadiazole, 2,5-Bis-(4-aminophenyl)-1,3,4-oxadiazole, 2-(4-Bromophenyl)-5-phenyl-1,3,4-oxadiazole, 4-Chloro-7-chlorosulfonyl-2,1,3-benzoxadiazole, 2,5-Diphenyl-1,3,4-oxadiazole, 5-(4-Methoxyphenyl)-1,3,4-oxadiazole-2-thiol, 5-(4-Methylphenyl)-1,3,4-oxadiazole-2-thiol, 5-Phenyl-1,3,4-oxadiazole-2-thiol, 5-(4-Pyridyl)-1,3,4-oxadiazole-2-thiol, Methyl viologen dichloride hydrate, Fullerene-C60, N-Methylfulleropyrrolidine, N,N′-Bis(3-methylphenyl)-N,N′-diphenylbenzidine, Triethylamine (TEA), Triethanolanime (TEA)—OH, Trioctylamine, Triphenylphosphine, Trioctylphosphine, Triethylphosphine, Tetradimethylaminoethene, Tris(diethylamino)phosphine, Pentacene, Tetracene, N,N′-Di-(1-naphthyl)-N,N′-diphenyl]-1,1′-biphenyl)-4,4′-diamine sublimed grade, 4-(Diphenylamino)benzaldehyde, Di-p-tolylamine, 3-Methyldiphenylamine, Triphenylamine, Tris[4-(diethylamino)phenyl]amine, Tri-p-tolylamine, Acradine Orange base, 3,8-Diamino-6-phenylphenanthridine, 4-(Diphenylamino)benzaldehyde diphenylhydrazone, Poly(9-vinylcarbazole), Poly(1-vinylnaphthalene), Triphenylphosphine, 4-Carboxybuutyl)triphenylphosphonium bromide, Tetrabutylammonium benzoate, Tetrabutylammonium hydroxide 30-hydrate, Tetrabutylammonium triiodide, Tetrabutylammonium bis-trifluoromethanesulfonimidate, Tetraethylammonium trifluoromethanesulfonate, Oleum (H₂SO₄—SO₃), Triflic acid and Magic Acid.

12. The method of claim 1, further comprising:
adding at least one stabilizer bonded to the functionalization material.

13. The nanostructure film of claim 1, further comprising:
adding at least one encapsulant on the nanostructure film.
